(19) United States
(12) Patent Application Publication
(10) Pub. No.: US 2023/0279997 A1
(43) Pub. Date: Sep. 7, 2023

(54) SYSTEM FOR LOADING LIQUID NATURAL GAS

(71) Applicant: GAZTRANSPORT ET TECHNIGAZ, Saint Remy Les Chevreuse (FR)

(72) Inventors: Bernard AOUN, Saint Remy Les Chevreuse (FR); Romain NARME, Saint Remy Les Chevreuse (FR); Guillaume LECLERE, Saint Remy Les Chevreuse (FR)

(73) Assignee: GAZTRANSPORT ET TECHNIGAZ, Saint Remy Les Chevreuse (FR)

(21) Appl. No.: 18/005,542

(22) PCT Filed: Jul. 15, 2021
(86) PCT No.: PCT/FR2021/051317

§ 371 Date: Jan. 13, 2023

(30) Foreign Application Priority Data
Jul. 17, 2020 (FR) FR2007556

(51) Int. Cl. F17C 9/00

(52) U.S. Cl. CPC F17C 9/00; F17C 2205/0326; F17C 2223/0161; F17C 2225/0169; F17C 2225/033; F17C 2227/0135; F17C 2227/0157; F17C 2227/0339; F17C 2227/036; F17C 2270/0105

(57) ABSTRACT

The present invention primarily relates to a loading system (1) configured to transfer a cryogenic fluid (3) from a storage vessel (2) into a receiving vessel (4), the loading system (1) comprising at least one element (17) for circulating the cryogenic fluid (3) in the liquid state which connects the storage vessel (2) to the receiving vessel (4), a processing and/or consumption unit (26) of the cryogenic fluid (3) in the gaseous state originating at least from the receiving vessel (4) and a return line (28) of the cryogenic fluid in the gaseous state which connects the receiving vessel (4) with the processing and/or consumption unit (26), characterised in that the loading system (1) comprises at least one cooling unit (36) of the cryogenic fluid (3) circulating towards the receiving vessel (4) in the circulation element (17), the cold generated by the cooling unit (36) resulting from an evaporation of the cryogenic fluid (3) coming from the storage vessel (2).

The present invention belongs to the field of systems for loading liquid natural gas (LNG), and more particularly systems for loading natural gas of a vessel equipping a floating structure.

Liquid natural gas is generally stored in a storage vessel, before being loaded into a receiving vessel of a floating structure. The liquid natural gas is kept at a temperature low enough to keep it in liquid form at atmospheric pressure in each of the vessels. Using a loading system to transfer the liquid natural gas from the storage vessel to the receiving vessel is known.

Such a loading system comprises at least one supply line through which the liquid natural gas flows from the storage vessel to the receiving vessel. When the liquid natural gas enters the receiving vessel, a temperature difference between the temperature of the fluid and the temperature inside the receiving vessel causes a portion of the natural gas to evaporate. Moreover, the liquid natural gas may be heated, for example when it passes through a pump arranged on the supply line and forcing the liquid natural gas to move through the supply line, and/or by thermal infiltration in the loading system, making it more likely to evaporate when it enters the receiving vessel. Equipping such loading systems with a system for processing and/or consuming the evaporated natural gas is known. Such loading systems comprise a gas return line and a unit for processing and/or consuming the evaporated natural gas, the evaporated gas in the receiving vessel flowing through the gas return line from the receiving vessel to the processing and/or consumption unit. The processing and/or consumption unit may, for example, be a liquefaction unit that converts the evaporated natural gas into liquid form, the liquid natural gas produced then being recirculated to the storage vessel, thus limiting the loss of natural gas in gaseous form.

The processing and/or consumption unit used in such loading systems is thus dimensioned to process a volume of natural gas in gaseous form that is determined by the specifications of the receiving vessel. Because this volume is considerable, the processing and/or consumption unit comprises technical means that are bulky, expensive and energy intensive.

In this context, the present invention proposes a loading system for loading cooled liquid natural gas from a storage vessel to a receiving vessel while reducing the quantity of natural gas in gaseous form generated while loading the receiving vessel, and while transporting the receiving vessel to the place where it will be unloaded, making it possible to reduce the capacity of the re-liquefaction units installed on the ship comprising at least one receiving vessel.

The present invention primarily relates to a loading system configured to transfer a cryogenic fluid from a storage vessel to a receiving vessel, the loading system comprising at least a flow element for the cryogenic fluid in the liquid state which connects the storage vessel to the receiving vessel, a unit for processing and/or consuming the cryogenic fluid in the gaseous state originating at least from the receiving vessel and a return line for the cryogenic fluid in the gaseous state which connects the receiving vessel to the processing and/or consumption unit, characterized in that the loading system comprises at least one unit for cooling the cryogenic fluid flowing through the flow element to the receiving vessel, the cold generated by the cooling unit resulting from the evaporation of the cryogenic fluid coming from the storage vessel.

The loading system transfers cryogenic fluid from the storage vessel to the receiving vessel, the cryogenic fluid flowing through the flow element. The cryogenic fluid flowing through the flow element is cooled by the cooling unit, the temperature of the cooled cryogenic fluid being lower than that of the cryogenic fluid flowing through the flow element upstream of the cooling unit. This has the effect of lowering the temperature of the cryogenic fluid loaded in the receiving vessel, thus limiting the evaporation of the cryogenic fluid received in the receiving vessel and ultimately allowing the capacity of the processing and/or consumption unit to be reduced, whether said unit is installed on a ship equipped with at least one receiving vessel and/or installed on the terminal with the storage vessel. The cold used to lower the temperature of the cryogenic fluid flowing through the flow element comes from the evaporation of a portion of the cryogenic fluid coming from the storage vessel. More specifically, this portion of cryogenic fluid is expanded, i.e., the pressure of this portion of cryogenic fluid is lowered, such that it lowers the temperature of the cryogenic fluid flowing through the additional supply line.

It should therefore be understood that the primary function of the loading system is to transfer cryogenic fluid from one vessel to the other while cooling it in order to cleverly limit the evaporation of said cryogenic fluid once transferred into the receiving vessel. As a result, the quantity of cryogenic fluid contained in the storage vessel will decrease as the cryogenic fluid is transferred by the loading system, and the quantity of cryogenic fluid contained in the receiving vessel will increase. The loading system thus causes the quantity of cryogenic fluid contained in each of the vessels to change, with the quantity of fluid in the storage vessel being reduced while that of the receiving vessel increases.

The drop in temperature of the cryogenic fluid sent to the receiving vessel limits the evaporation of the cryogenic fluid contained in the receiving vessel. Indeed, by virtue of the cooling unit, the temperature of the cryogenic fluid transferred into the receiving vessel is lower than the temperature of the cryogenic fluid contained in the storage vessel.

Furthermore, “processing and/or consumption unit” should be understood to mean a unit that can either modify the temperature, the pressure and/or the state of the natural gas flowing through it, or use the natural gas to produce energy, for example thermal or mechanical energy, or both at the same time. The processing unit may, for example, be a liquefaction unit, a compression member, while the consumption unit may, for example, be an engine, for example using the natural gas as fuel.

Moreover, one and/or both of the storage vessel and the receiving vessel may be a type of vessel chosen from an onshore cryogenic fluid tank, a transportation vessel installed on a ship, a fuel tank of a passenger and/or cargo ship, a gravity-based structure, a floating storage unit for cryogenic fluid or a floating storage and regasification unit for cryogenic fluid.

According to one optional feature of the invention, the storage vessel is an onshore tank or a gravity-based structure, whereas the receiving vessel is a transportation vessel installed on a ship or a fuel tank of a passenger and/or cargo ship. According to another optional feature of the invention, the storage vessel is a floating storage unit for cryogenic fluid whereas the receiving vessel is a transportation vessel installed on a ship.

According to another optional feature of the invention, the storage vessel is a transportation vessel installed on a ship whereas the receiving vessel is a fuel tank of a passenger and/or cargo ship.

According to another optional feature of the invention, the storage vessel is a transportation vessel installed on a ship whereas the receiving vessel is a floating storage and regasification unit for cryogenic fluid.

According to another optional feature of the invention, the flow element comprises a main supply line for cryogenic fluid in the liquid state which connects the storage vessel to the receiving vessel, the cooling unit cooling the cryogenic fluid in the liquid state flowing through the main supply line.

It should be understood that the cryogenic fluid flowing through the main supply line from the storage vessel to the receiving vessel is cooled by the cooling unit. According to another optional feature of the invention, the flow element comprises a main supply line for cryogenic fluid in the liquid state which connects the storage vessel to the receiving vessel and at least one additional supply line for the cryogenic fluid in the liquid state coming from the storage vessel and flowing to the receiving vessel, the cooling unit cooling the cryogenic fluid in the liquid state flowing through the additional supply line.

The loading system transfers cryogenic fluid from the storage vessel to the receiving vessel, the cryogenic fluid flowing through the main supply line and through the additional supply line. The cryogenic fluid flowing through the additional supply line is cooled by the cooling unit, the temperature of the cooled cryogenic fluid being lower than that of the cryogenic fluid flowing through the main supply line. This has the effect of lowering the temperature of the cryogenic fluid loaded in the receiving vessel, thus limiting the evaporation of the cryogenic fluid received in the receiving vessel and ultimately allowing the capacity of the processing and/or consumption unit to be reduced, whether said unit is installed on a ship equipped with at least one receiving vessel and/or installed on the terminal with the storage vessel.

Advantageously, the cooling unit only cools the cryogenic fluid flowing through the additional supply line, the cryogenic fluid flowing through the main supply line not being treated by the cooling unit.

It should be understood that the additional supply line may be directly or indirectly connected to one or the other of the vessels. Indeed, the additional supply line may extend from one vessel to the other, being totally separate from the main supply line, or may branch from and/or lead into the main supply line.

According to another optional feature of the invention, the cooling unit comprises a pipe through which cryogenic fluid flows and which connects the storage vessel to the processing and/or consumption unit, the cooling unit comprising at least an expansion member, a heat exchanger and a compression device arranged in that order on the pipe, the heat exchanger exchanging calories between the cryogenic fluid flowing through the additional supply line and the pipe.

More specifically, the cryogenic fluid coming from the storage vessel flows through the pipe, this cryogenic fluid being expanded by the expansion member before flowing through the heat exchanger. When it passes through the heat exchanger, the cryogenic fluid flowing through the additional supply line transfers calories to the expanded cryogenic fluid also flowing through the heat exchanger, the cryogenic fluid flowing through the additional supply line thus being cooled to a temperature lower than that of the cryogenic fluid flowing through the main supply line.

In other words, the cryogenic fluid flowing through the pipe and passing through the heat exchanger is re-heated and evaporated in the heat exchanger by capturing calories coming from the cryogenic fluid flowing through the additional supply line, then sucked in and compressed by the compression device. During the suction operation, the compression device creates a vacuum in the heat exchanger, lowering the pressure of the cryogenic fluid present upstream of the compression device and downstream of the expansion member. The pressure of the cryogenic fluid then changes, by virtue of the compression device, from a pressure lower than atmospheric pressure to a pressure higher than atmospheric pressure, the compressed cryogenic fluid in the gaseous state then being sent to the processing and/or consumption unit.

Furthermore, it is inside the heat exchanger that the temperature of the cryogenic fluid flowing through the additional supply line drops below the temperature of the cryogenic fluid flowing through the main supply pipe, in particular due to the transmission of calories from the cryogenic fluid flowing through the additional supply line to the cryogenic fluid flowing through the pipe. It should be understood that the temperature of the cryogenic fluid flowing through the additional supply line is lowered during the exchange of calories that takes place in the heat exchanger.

According to another optional feature of the invention, the heat exchanger comprises at least a first pass constituting the pipe and a second pass constituting the additional supply line, the expansion member being arranged upstream of the first pass. In other words, the cryogenic fluid flowing through the additional supply line also flows through the second pass whereas the cryogenic fluid flowing through the pipe travels through the first pass.

It should be understood that, in this configuration, the cryogenic fluid flowing through the pipe is expanded before flowing through the first pass of the heat exchanger.

According to another optional feature of the invention, the compression device is installed on the pipe between the heat exchanger and the processing and/or consumption unit.

According to another optional feature of the invention, the cryogenic fluid is in the gaseous state between the first pass and the compressor.

The compression device sucks in and then increases the pressure of the cryogenic fluid flowing through the pipe downstream of the first pass of the heat exchanger. According to another optional feature of the invention, the exchange of heat in the heat exchanger takes place between the cryogenic fluid in the liquid state flowing through the additional supply line and the two-phase cryogenic fluid flowing through the pipe before it enters the heat exchanger, the cryogenic fluid flowing through the pipe passing from the two-phase state to the gaseous state inside the heat exchanger.

According to another optional feature of the invention, the first pass of the heat exchanger is configured to be subjected to pressure lower than atmospheric pressure.

This pressure level in the first pass results from the restricted flow generated by the expansion member combined with the suction produced by the compression device, thus creating a vacuum in the volume of the pipe situated between the expansion member and the compression device.

According to another optional feature of the invention, the loading system is configured so that the temperature of the cryogenic fluid flowing through the additional supply line between the heat exchanger and the receiving vessel is at least 2° C. lower than the temperature of the cryogenic fluid flowing through the main supply line. Preferably, the temperature difference between the cryogenic fluid flowing downstream of the second pass and the cryogenic fluid flowing through the main supply line is at least 5° C.

According to another optional feature of the invention, the temperature difference between the cryogenic fluid flowing downstream of the second pass and the cryogenic fluid flowing through the main supply line is at least 8° C.

The temperature reached by the cryogenic fluid that flows through the additional supply line allows the overall temperature of the cargo loaded into the receiving vessel to be reduced by between approximately 0.5° C. and 1° C. Such a reduction significantly limits the evaporation of the natural gas loaded into the receiving vessel by the loading system according to the invention. The effect of this advantage of the invention is to allow the capacity for liquefying the evaporated cryogenic fluid to be reduced by installing smaller processing and/or consumption units.

According to another optional feature of the invention, the cooling circuit comprises a valve for controlling the flow rate of the cryogenic fluid positioned on the main supply line or on the additional supply line upstream of the expansion member.

According to another optional feature of the invention, the additional supply line and the pipe are connected to the main supply line.

According to one alternative, the pipe originates from the additional supply line. According to another optional feature of the invention, the storage vessel comprises at least one pump configured to cause the cryogenic fluid to flow in the main supply line, the additional supply line and the pipe.

According to another optional feature of the invention, the loading system comprises a channel for cryogenic fluid in the gaseous state connecting the storage vessel to the pipe, the channel being configured to convey the cryogenic fluid in the gaseous state from the storage vessel to the processing and/or consumption unit. The present invention also relates to an assembly comprising a floating structure comprising the receiving vessel, a loading terminal comprising the storage vessel and a loading system according to any one of the features listed in the present document connecting the loading terminal to the floating structure.

According to another optional feature of the invention, the receiving vessel comprises at least a bottom wall and a top wall, the main supply line opening closer to the bottom wall than the top wall.

In this configuration, the cryogenic fluid coming from the additional supply line mixes with the cryogenic fluid stored in the receiving vessel and helps cool the cryogenic fluid contained in the receiving vessel.

The present invention also relates to a method for loading a receiving vessel by using a loading system according to any one of the preceding features, during which a cryogenic fluid in the liquid state is conveyed through the main supply line and the additional supply line from a storage vessel to the receiving vessel, and during which the cryogenic fluid flowing through the additional supply line is cooled to a temperature lower than that of the cryogenic fluid flowing through the main supply line, by expanding the cryogenic fluid coming from the storage vessel.

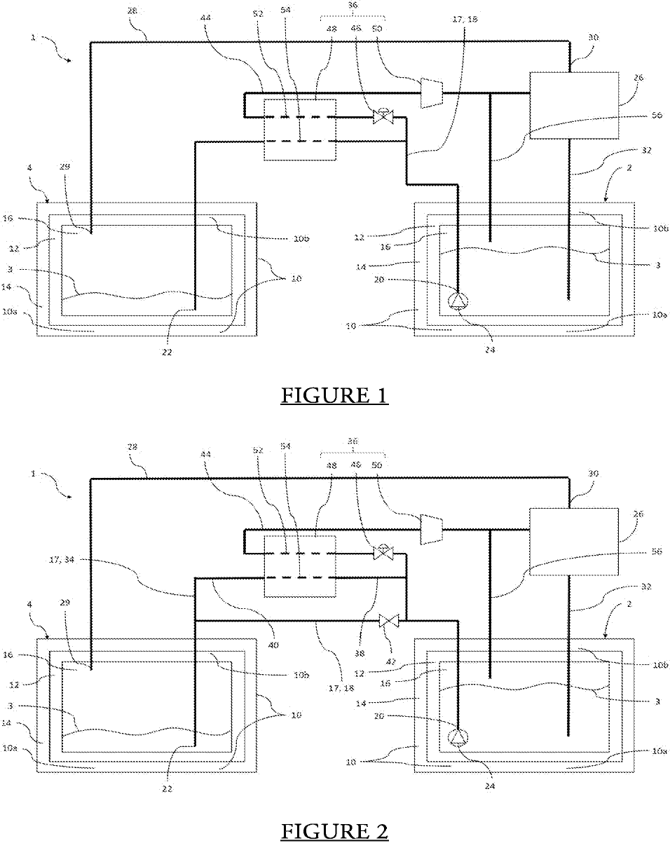

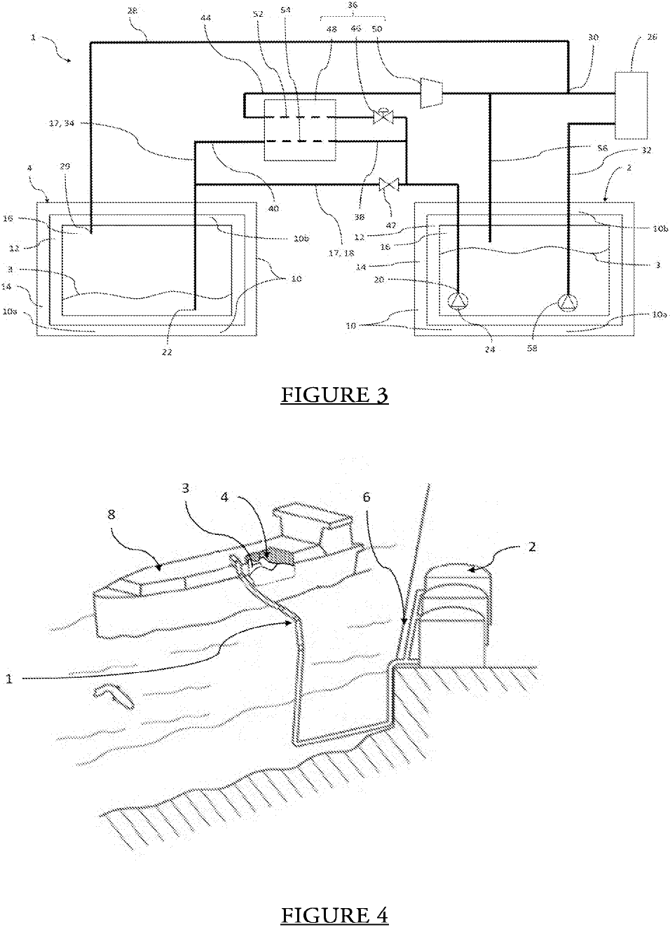

Other features, details and advantages of the invention will become clearer on reading the description that follows, on the one hand, and several embodiments provided as non-limiting examples in reference to the appended schematic drawings, on the other hand, in which:

[FIG. 1] is a schematic representation of a loading system according to the invention and according to a first embodiment;

[FIG. 2] is a schematic representation of a loading system according to the invention and according to a second embodiment;

[FIG. 3] is a schematic representation of a loading system according to the invention and according to a third embodiment;

[FIG. 4] is a perspective view of the loading system according to FIG. 1 connecting a receiving vessel of a floating structure to a storage vessel of a loading terminal.

The features, variants and different embodiments of the invention can be associated with each other in various combinations, provided they are not incompatible with or exclusive of each other. In particular, it is possible to envisage variants of the invention that only comprise a selection of the features described below in isolation from the other described features, if said selection of features is sufficient to give the invention a technical advantage over and/or distinguish it from the prior art. Hereinafter in the description, the terms “upstream” and “downstream” refer to the direction in which a cryogenic fluid flows through the component in question in the liquid, gaseous or two-phase state.

FIGS. 1 to 4 show a loading system 1 configured to transfer a cryogenic fluid 3 from a storage vessel 2 to a receiving vessel 4. “Storage vessel 2” should be understood to mean a vessel in which the cryogenic fluid 3 is stored initially, and “receiving vessel 4” should be understood to mean a vessel into which the cryogenic fluid 3 coming from the storage vessel 2 is conveyed.

As shown more particularly in FIG. 4, the storage vessel 2 may, for example, be installed on a loading terminal 6, such as the quay of a port, for example, and the receiving vessel 4 may, for example, be installed on a floating structure 8, such as a transport ship, for example, the floating structure 8 being close to the loading terminal 6 in order to load cryogenic fluid 3 from the storage vessel 2 into the receiving vessel 4 of said structure.

As shown in FIG. 1, at least one of the vessels 2, 4, and advantageously the receiving vessel 4, is constituted by sealed and thermally insulating layers 10 configured to keep the cryogenic fluid 3 at a temperature lower than its evaporating temperature, for example -163° C. Preferably, the receiving vessel 4 and the storage vessel 2 are constituted by such sealed and thermally insulating layers 10. The cryogenic fluid 3 is, for example, liquid natural gas (LNG) that is in the liquid state at a temperature less than or equal to -163° C. at atmospheric pressure.

In order to keep the cryogenic fluid 3 at as low a temperature as possible, each vessel 2, 4 comprises, for example, at least a sealed and thermally insulating primary space 12 in contact with the cryogenic fluid 3 contained in the vessel 2, 4 and a sealed and thermally insulating secondary space 14 enveloping the primary space 12 and generally supported by a load-bearing structure.

Furthermore, each vessel 2, 4 comprises a bottom wall 10a and a top wall 10b, the cryogenic fluid 3 in the liquid state resting on the bottom wall 10a, and the cryogenic fluid in the gaseous state generally being located at the top wall 10b in a space referred to as the headspace 16 hereinafter in the description.

The cryogenic fluid 3 is transported through the loading system 1 to flow from the storage vessel 2 to the receiving vessel 4. For this purpose, the loading system 1 comprises at least one flow element 17 for the cryogenic fluid 3 in the liquid state which connects the storage vessel 2 to the receiving vessel 4. This flow element 17 comprises at least one main supply line 18 that extends from the storage vessel 2 to the receiving vessel 4 between a line inlet 20 installed at the bottom wall 10a of the storage vessel 2 and a line outlet 22 installed at the bottom wall 10a of the receiving vessel 4.

As shown in FIG. 1, the loading system 1 comprises at least one pump 24 installed at the line inlet 20 of the main supply line 18. The pump 24 is configured to cause the cryogenic fluid 3 to flow from the storage vessel 2 to the receiving vessel 4 through at least the main supply line 18 of the loading system 1. Furthermore, the pump 24 may cause the pressure of the cryogenic fluid flowing through the main supply line 18 to increase, the pressure of the cryogenic fluid possibly being higher than atmospheric pressure, for example up to 10 bars.

A portion of the cryogenic fluid 3 generally evaporates when it enters the receiving vessel 4. The cryogenic fluid in the gaseous state present in the receiving vessel 4 naturally moves towards the top wall 10b and forms the headspace 16 of the receiving vessel 4. In order to optimize the quantity of cryogenic fluid stored, the loading system 1 comprises at least one unit 26 for processing and/or consuming the cryogenic fluid in the gaseous state originating at least from the receiving vessel 4 and one return line 28 for the cryogenic fluid in the gaseous state that connects the receiving vessel 4 to the processing and/or consumption unit 26.

As shown in FIG. 1, the fluid return line 28 comprises a gas inlet 29 installed at the top wall 10b of the receiving vessel 4 so as to communicate aeraulically with the headspace 16 of the receiving vessel 4, and a gas outlet 30 installed at the processing and/or consumption unit 26. The cryogenic fluid in the gaseous state present in the headspace 16 of the receiving vessel 4 therefore flows through the fluid return line 28 from the receiving vessel 4 to the processing and/or consumption unit 26.

According to a first embodiment and as shown in FIG. 1, the processing and/or consumption unit is a liquefaction unit 26 configured to convert the cryogenic fluid from the gaseous state to the liquid state. Generally, the liquefaction unit 26 comprises a heat exchanger responsible for condensing the natural gas vapors captured in the headspace 16. At this stage, the cryogenic fluid passes from the gaseous state to the liquid state. The cryogenic fluid exits the liquefaction unit 26 in the liquid state, and then flows through a fluid return tube 32 opening at the bottom wall 10a of the storage vessel 2.

According to the invention and as shown in FIG. 1, the loading system 1 comprises at least one unit 36 for cooling the cryogenic fluid 3 flowing through the flow element 17 to the receiving vessel 4, the cold generated by the cooling unit 36 resulting from the evaporation of the cryogenic fluid 3 coming from the storage vessel 2. It should be understood that the cooling unit 36 cools the cryogenic fluid 3 flowing through the main supply line 18 from the storage vessel 2 to the receiving vessel 4. Therefore, the temperature of the cryogenic fluid 3 in the liquid state flowing through the main supply line 18 downstream of the cooling unit 36 is lower than the temperature of the cryogenic fluid 3 flowing through the main supply line 18 upstream of the cooling unit 36.

The loading system 1 comprises a pipe 44 connected to the processing and/or consumption unit 26 and in which the cryogenic fluid flows, the pipe 44 being part of the cooling unit 36. The pipe 44 is connected in this instance to the main supply line 18 to extend to the processing and/or consumption unit 26.

The cooling unit 36 comprises at least an expansion member 46, a heat exchanger 48 and a compression device 50 arranged on the pipe 44.

The heat exchanger 48 of the cooling unit 36 comprises at least a first pass 52 constituting the pipe 44 and a second pass 54 constituting the main supply line 18. Configured in this way, the heat exchanger 48 exchanges calories between the cryogenic fluid flowing through the main supply line 18 and the cryogenic fluid flowing through the pipe 44, the exchange of calories between the cryogenic fluid flowing through the main supply line 18 and the cryogenic fluid flowing through the pipe 44 taking place, in particular, at the first and second passes 52, 54 of the heat exchanger 48. The calories exchanged between the cryogenic fluid flowing through the main supply line 18 and the cryogenic fluid flowing through the pipe 44 cause the temperature of the cryogenic fluid flowing through the main supply line 18 to drop, the cryogenic fluid flowing through the main supply line 18 transferring calories to the cryogenic fluid flowing through the pipe 44.

This transfer of calories is achieved by the presence of the expansion member 46 which reduces the pressure of the cryogenic fluid, thus facilitating its change of state.

According to the invention, the temperature of the cryogenic fluid flowing through the main supply line 18 downstream of the second pass 54 of the heat exchanger 48 is at least 2° C. lower than the temperature of the cryogenic fluid flowing through the main supply line 18 upstream of the second pass 54 of the heat exchanger 48. Advantageously, the temperature difference between the cryogenic fluid flowing through the main supply line 18 downstream of the second pass 54 of the heat exchanger 48 and the cryogenic fluid flowing through the pipe 44 is at least 8° C. As shown in FIG. 1, the expansion member 46 of the cooling unit 36 is installed upstream of the first pass 52 on the pipe 44. In other words, it should be understood that the cryogenic fluid in the liquid state that supplies the first pass 52 undergoes expansion, i.e., a reduction in its pressure before joining the first pass 52, causing the cryogenic fluid to change state, thus changing from a liquid state to a two-phase state in which one portion of the cryogenic fluid is in the liquid state and another portion is in the gaseous state. Conversely, the cryogenic fluid in the liquid state flowing through the second pass 54 of the heat exchanger 48 joins said second pass 54 without undergoing any change in pressure or temperature apart from that related to the pumping operation itself. In other words, it should be understood that this heat exchanger 48 is configured to carry out heat exchange between cryogenic fluid in the expanded gaseous state and cryogenic fluid in the non-expanded liquid state. For example, the cryogenic fluid may be expanded to a pressure lower than atmospheric pressure, causing the cryogenic fluid to change from a pressure of at most 10 bars upstream of the expansion member 46 to a pressure of 0.5 bar between the expansion member 46 and the compression device 50.

Advantageously, the difference in pressure, and therefore temperature, between the cryogenic fluid in the gaseous state flowing through the first pass 52 and the cryogenic fluid in the liquid state flowing through the second pass 54 causes the cryogenic fluid in the liquid state flowing through the second pass 54 to cool and the cryogenic fluid in the two-phase state entering the first pass 52 to evaporate. An outlet port of the second pass 54 of the heat exchanger 48 is fluidically connected to the receiving vessel 4 such that the cryogenic fluid in the liquid state cooled by passing through the second pass 54 of the heat exchanger 48 can flow to the receiving vessel 4. It should be understood that injecting cryogenic fluid in the liquid state that has been cooled in this way helps to reduce the temperature of the cargo sent into the receiving vessel 4, and thus to limit the evaporation of the cryogenic fluid 3 contained in the receiving vessel 4.

As described above, the cryogenic fluid flowing downstream of the first pass 52 of the heat exchanger 48 is in the gaseous state. The compression device 50 is advantageously installed on the pipe 44 downstream of the heat exchanger 48 and upstream of the liquefaction unit 26. The cryogenic fluid in the gaseous state exiting the first pass 52 of the heat exchanger 48 is sucked into the pipe 44 by the compression device 50. Sucking the cryogenic fluid in the gaseous state creates a vacuum in the volume of the circuit situated between an outlet of the expansion member 46 and an inlet of the compression device 50. The pressure of the cryogenic fluid in this circuit portion is between 0.5 bar and 0.35 bar, absolute pressure.

The compression device 50 is configured to compress the cryogenic fluid in the gaseous state. “Compress” should be understood to mean that the pressure of the cryogenic fluid is increased by the compression device 50, making the cryogenic fluid in the gaseous state change from a pressure of 0.35 bar, for example, to a pressure high enough for the cryogenic fluid to reach the processing and/or consumption unit 26.

The pipe 44 fluidically connects the compression device 50 to the processing and/or consumption unit 26 so that the cryogenic fluid in the compressed gaseous state can flow to the processing and/or consumption unit 26.

When the processing and/or consumption unit 26 is a liquefaction unit 26, as shown, for example, in FIG. 1, the cryogenic fluid in the compressed gaseous state is liquefied in the liquefaction unit 26, by reducing the temperature of the cryogenic fluid.

Furthermore, the loading system 1 may comprise a channel 56 for cryogenic fluid in the gaseous state connecting the storage vessel 2 to the pipe 44, the channel 56 being configured to convey the cryogenic fluid in the gaseous state from the storage vessel 2 to the processing and/or consumption unit 26. More specifically, the channel 56 extends from the top wall 10b of the storage vessel 2, thus connecting the headspace 16 of the storage vessel 2 to the pipe 44, the channel 56 opening downstream of the compression device 50 and upstream of the liquefaction unit 26. The cryogenic fluid 3 evaporating in the storage vessel 2, thus changing from a liquid state to a gaseous state, flows through the channel 56 and then through a portion of the pipe 44 to the processing and/or consumption unit 26. The cryogenic fluid in the gaseous state coming from the storage vessel 2 and flowing through the channel 56 mixes with the cryogenic fluid in the gaseous state flowing through the pipe 44 in order to then be liquefied in the processing and/or consumption unit 26. There now follows a description of a second embodiment in reference to FIG. 2. As shown in FIG. 2, the flow element 17 comprises at least one additional supply line 34 for the cryogenic fluid in the liquid state, separate from the main supply line 18, and which fluidically connects the storage vessel 2 to the receiving vessel 4.

The cooling unit 36 cools the cryogenic fluid flowing through the additional supply line 34, the cold generated by the cooling unit 36 resulting from the evaporation of the cryogenic fluid 3 coming from the storage vessel 2. Therefore, the additional supply line 34 comprises a first portion 38 upstream of the cooling unit 36 and a second portion 40 downstream of the cooling unit 36. The temperature of the cryogenic fluid flowing through the second portion 40 of the additional supply line 34 is lower than the temperature of the cryogenic fluid flowing through the main supply line 18.

The loading system 1 may comprise a control valve 42 for controlling the flow rate of the cryogenic fluid positioned on the main supply line 18. More specifically, the control valve 42 is installed downstream of the intersection between the first portion 38 of the additional supply line 34 and controls the flow rate of cryogenic fluid flowing through the main supply line 18. It should be understood that the control valve 42 may prevent the cryogenic fluid in the liquid state from flowing through the main supply pipe 18 downstream of the control valve 42, all of the cryogenic fluid sent by the pump 24 into the main supply line 18 upstream of the control valve 42 then passing through the additional supply line 34. In other words, the control valve 42 may guide all, or only a portion, of the cryogenic fluid to the additional supply line 34.

According to another embodiment that is an alternative to that described above, the loading system comprises a control valve 42 for controlling the flow rate of the cryogenic fluid positioned on the additional supply line 18. More specifically, the control valve 42 is installed on the first portion 38 of the additional supply line 34 and controls the flow rate of the cryogenic fluid flowing through the additional supply line 34.

The pipe 44 is connected in this instance to the additional supply line 34 to extend to the processing and/or consumption unit 26. More specifically, the pipe 44 extends from the first portion 38 of the additional supply line 34, between the control valve 42 and the cooling unit 36, and the liquefaction unit 26.

As shown in FIG. 2, the additional supply line 34 and the pipe 44 are connected to the main supply line 18, the cryogenic fluid being caused to flow through the main supply line 18, the additional supply line 34 and the pipe 44 by the pump 24 installed at the line inlet 20 of the main supply line 18. Moreover, and as shown in this instance in FIG. 2, the additional supply line 34 opens into the main supply line 18 downstream of the control valve 42. However, the additional supply line 34 may open at the bottom wall 10a of the receiving vessel 4 without departing from the scope of the invention.

The first pass 52 of the heat exchanger 48 in this instance constitutes the pipe 44 and the second pass 54 constitutes the additional supply line 34. Configured in this way, the heat exchanger 48 exchanges calories between the cryogenic fluid flowing through the additional supply line 34 and the cryogenic fluid flowing through the pipe 44, the exchange of calories between the cryogenic fluid flowing through the additional supply line 34 and the cryogenic fluid flowing through the pipe 44 taking place, in particular, at the first and second passes 52, 54 of the heat exchanger 48. The calories exchanged between the cryogenic fluid flowing through the additional supply line 34 and the cryogenic fluid flowing through the pipe 44 cause the temperature of the cryogenic fluid flowing through the additional supply line 34 to drop, the cryogenic fluid flowing through the additional supply line 34 transferring calories to the cryogenic fluid flowing through the pipe 44.

This transfer of calories is achieved by the presence of the expansion member 46 which reduces the pressure of the cryogenic fluid, thus facilitating its change of state, the operation of the heat exchanger 48 in this second embodiment being similar to that described in the first embodiment.

According to the invention, the temperature of the cryogenic fluid flowing through the additional supply line 34 downstream of the second pass 54, i.e., in the second portion 40 of the additional supply line 34 of the heat exchanger 48 is at least 2° C. lower than the temperature of the cryogenic fluid flowing through the main supply line 18. Advantageously, the temperature difference between the cryogenic fluid flowing through the additional supply line 34 downstream of the second pass 54 and the cryogenic fluid flowing through the additional supply line 34 upstream of the second pass 54 is at least 8° C.

According to another embodiment that is an alternative to the embodiment described above, the main supply line 18, the additional supply line 34 and the pipe 44 each emerge separately into the storage vessel 2. The main supply line 18, the additional supply line 34 and the pipe 44 then each comprise a pump 24 installed at their respective inlets, forcing the cryogenic fluid 3 to flow through each of the supply lines 18, 34 and the pipe 44. Moreover, and without departing from the scope of the invention, only the main 18 and additional 34 supply lines can extend from the storage vessel 2, the pipe 44 being able to be connected to the additional supply line 34 as described above.

There now follows a description of a third embodiment that differs from the first and second embodiments in that the processing and/or consumption unit 26 is a device that consumes natural gas in the gaseous state, as shown more particularly in FIG. 3.

In reference to FIG. 3, the processing and/or consumption unit 26 is a device that consumes natural gas in the gaseous state, i.e., the consumption device 26 uses natural gas in the gaseous state as fuel.

For this purpose, the natural gas in the gaseous state supplying the consumption device 26 comes from the headspace 16 of the receiving 4 and storage 2 vessels. The gas outlet 30 of the return line 28 opens in this instance at the pipe 44, between the compression device 50 and the consumption device 26. The natural gas in the gaseous state flowing through the return line 28 to the consumption device 26 thus mixes with the natural gas in the compressed gaseous state flowing through the pipe 44 downstream of the compression member 50 and the channel 56 to the consumption device 26. Furthermore, the latter then uses the mixture of natural gas in the gaseous state coming from the pipe 44 as fuel for its operation.

Alternatively, and/or additionally, the return tube 32 may be equipped with a pumping member 58 at its end opening into the storage vessel 2, the pumping member 58 being configured to force natural gas in the liquid state to flow through the return tube 32 to the consumption device 26. It should be understood that the consumption device 26 may be supplied with natural gas in the liquid state coming from the storage vessel 2 through the return tube 32 and/or with natural gas in the gaseous state coming from the pipe 44.

The invention also relates to a method for loading the receiving vessel 4 using the loading system 1, the method comprising at least one step that may be carried out in addition to other methods for loading cryogenic fluid that already exist, if the means implemented allow this.

During this loading method, the cryogenic fluid 3 in the liquid state is conveyed through the main supply line 18 and through the additional supply line 34 from the storage vessel 2 to the receiving vessel 4. In other words, the pump 24 installed at the line inlet 20 of the main supply line 18 sucks the cryogenic fluid 3 in the liquid state present in the storage vessel 2 and injects it into the main supply line 18, being capable of changing its pressure from 1 bar to 10 bars.

The cryogenic fluid in the liquid state then advantageously flows mostly through the main supply line 18 directly to the bottom wall 10a of the receiving vessel 4, the flow rate of cryogenic fluid in this portion being controlled by the control valve 42. However, a portion of the cryogenic fluid in the liquid state branches off into the first portion 38 of the additional supply line 34. The cryogenic fluid in the liquid state flowing through the first portion 38 of the additional supply line 34 is divided again, with one portion flowing to the second pass 54 of the heat exchanger 48 and another portion being conveyed by the pipe 44 to the expansion member 46. The cryogenic fluid in the liquid state flowing through the pipe 44 is then expanded, passing through the expansion member 46, its pressure changing, for example, to 0.5 bar, making the cryogenic fluid change from a liquid state to a two-phase state, as explained earlier in the description above.

The cryogenic fluid in the liquid state flowing through the first portion 38 of the additional supply line 34 to the receiving vessel 4 passes through the second pass 54 of the heat exchanger 48. The cryogenic fluid in the two-phase state flowing through the pipe 44 downstream of the expansion member 46 passes through the first pass 52 of the heat exchanger 48. The cryogenic fluid in the liquid state flowing through the second pass 54 exchanges calories with the cryogenic fluid in the two-phase state flowing through the first pass 52. More specifically, the cryogenic fluid in the liquid state transfers calories to the cryogenic fluid in the two-phase state. As it travels through the respective passes, the temperature of the cryogenic fluid in the liquid state flowing through the second pass 54 of the heat exchanger 48 drops whereas the temperature of the cryogenic fluid in the two-phase state flowing through the first pass 52 of the heat exchanger 48 increases, making it change from a two-phase state to a gaseous state.

The cryogenic fluid in the liquid state flowing through the additional supply line 34 is cooled until it reaches a temperature lower than that of the cryogenic fluid in the liquid state flowing through the main supply line 18, as a result of the expansion of the cryogenic fluid coming from the storage vessel 2 and flowing through the pipe 44 passing through the expansion member 46. The cryogenic fluid in the cooled liquid state then flows to the main supply line 18 downstream of the control valve 42, and then through the main supply line 18, to the bottom wall 10a of the receiving vessel 4. The cryogenic fluid in the gaseous state flows to the compression device 50, which compresses it and increases its pressure, making it change, for example, from 0.35 bar to a pressure compatible with the operation of the liquefaction unit 26. The cryogenic fluid in the compressed gaseous state then flows through the pipe 44 to the processing and/or consumption unit 26, mixing with the cryogenic fluid in the gaseous state coming from the channel 56. The cryogenic fluid in the gaseous state is then liquefied in the liquefaction unit 26 before returning to the bottom of the storage vessel 2, in particular through the return tube 32, or is consumed by the consumption device 26.

However, the invention is not limited to the means and configurations described and illustrated in this document. It also covers any equivalent means or configuration and to any technical combination making use of such means. In particular, the connections between the main supply line 18, the additional supply line 34 and the pipe 44 may vary, as mentioned earlier in the description above. Moreover, the pressure values indicated above are not strictly limiting and may vary substantially, provided that this contributes to the proper functioning of the invention.

1. A loading system configured to transfer a cryogenic fluid from a storage vessel to a receiving vessel, the loading system comprising at least a flow element for the cryogenic fluid in the liquid state which connects the storage vessel to the receiving vessel, a unit for processing and/or consuming the cryogenic fluid in the gaseous state originating at least from the receiving vessel and a return line for the cryogenic fluid in the gaseous state which connects the receiving vessel to the processing and/or consumption unit, wherein the loading system comprises at least one unit for cooling the cryogenic fluid flowing through the flow element to the receiving vessel, the cold generated by the cooling unit resulting from the evaporation of the cryogenic fluid coming from the storage vessel.

2. The loading system as claimed in claim 1, wherein the flow element comprises a main supply line for the cryogenic fluid in the liquid state which connects the storage vessel to the receiving vessel, the cooling unit cooling the cryogenic fluid in the liquid state flowing through the main supply line.

3. The loading system as claimed in claim 1, wherein the flow element comprises a main supply line for the cryogenic fluid in the liquid state which connects the storage vessel to the receiving vessel and at least one additional supply line for the cryogenic fluid in the liquid state coming from the storage vessel and flowing to the receiving vessel, the cooling unit cooling the cryogenic fluid in the liquid state flowing through the additional supply line.

4. The loading system as claimed in claim 3, wherein the cooling unit comprises a pipe through which cryogenic fluid flows and which connects the storage vessel to the processing and/or consumption unit, the cooling unit comprising at least an expansion member, a heat exchanger and a compression device arranged in that order on the pipe, the heat exchanger exchanging calories between the cryogenic fluid flowing through the additional supply line and the pipe.

5. The loading system as claimed in claim 4, wherein the heat exchanger comprises at least a first pass constituting the pipe and a second pass constituting the additional supply line, the expansion member being arranged upstream of the first pass.

6. The loading system as claimed in claim 4, wherein the compression device is installed on the pipe between the heat exchanger and the processing and/or consumption unit.

7. The loading system as claimed in claim 5, wherein the first pass of the heat exchanger is configured to be subjected to pressure lower than atmospheric pressure.

8. The loading system as claimed in claim 4, configured such that the temperature of the cryogenic fluid flowing through the additional supply line between the heat exchanger and the receiving vessel is at least 2° C. lower than the temperature of the cryogenic fluid flowing through the main supply line.

9. The loading system as claimed in claim 4, comprising a control valve for controlling the flow rate of cryogenic fluid positioned on the main supply line or on the additional supply line upstream of the expansion member.

10. The loading system as claimed in claim 4, wherein the additional supply line and the pipe are connected to the main supply line.

11. The loading system as claimed in claim 4, wherein the storage vessel comprises at least one pump configured to cause the cryogenic fluid to flow through the main supply line, the additional supply line and the pipe.

12. The loading system as claimed in claim 4, comprising a channel for cryogenic fluid in the gaseous state connecting the storage vessel to the pipe, the channel being configured to convey the cryogenic fluid in the gaseous state from the storage vessel to the processing and/or consumption unit.

13. An assembly comprising a floating structure comprising a receiving vessel, a loading terminal comprising a storage vessel and a loading system according to claim 1, connecting the loading terminal to the floating structure.

14. An assembly comprising a floating structure comprising a receiving vessel, a loading terminal comprising a storage vessel and a loading system according to claim 1, connecting the loading terminal to the floating structure,
wherein the flow element comprises a main supply line for the cryogenic fluid in the liquid state which connects the storage vessel to the receiving vessel, the cooling unit cooling the cryogenic fluid in the liquid state flowing through the main supply line,
wherein at least the receiving vessel comprises at least a bottom wall and a top wall, the main supply line opening closer to the bottom wall than to the top wall.

15. A method for loading a receiving vessel by using a loading system as claimed in claim 3, during which a cryogenic fluid in the liquid state is conveyed through the main supply line and the additional supply line from a storage vessel to the receiving vessel, and during which the cryogenic fluid flowing through the additional supply line is cooled to a temperature lower than that of the cryogenic fluid flowing through the main supply line by expanding the cryogenic fluid coming from the storage vessel.
